(19) United States
(12) Patent Application Publication
(10) Pub. No.: US 2010/0306207 A1
(43) Pub. Date: Dec. 2, 2010

(54) METHOD AND SYSTEM FOR TRANSFORMING XML DATA TO RDF DATA

(75) Inventors: Han Yu Li, Beijing (CN); Sheng Ping Liu, Beijing (CN); Jing Mei, Beijing (CN); Yuan Ni, Beijing (CN); Guo Tong Xie, Beijing (CN)

Correspondence Address: IBM CORPORATION, T.J. WATSON RESEARCH CENTER, P.O. BOX 218, YORKTOWN HEIGHTS, NY, 10598, US

(73) Assignee: IBM CORPORATION, Yorktown Heights, NY (US)

(21) Appl. No.: 12/787,494

(22) Filed: May 26, 2010

(30) Foreign Application Priority Data
May 27, 2009 (CN) 200910203107.5

(51) Int. Cl. G06F 17/30

(52) U.S. Cl. 707/756; 707/E17.044

(57) ABSTRACT

A method for transforming Extensible Markup Language (XML) data to Resource Description Framework (RDF) data. The method includes the steps of: receiving a predefined mapping file; retrieving the correspondences between XML elements and/or attributes in the XML data and/or properties and concepts of the RDF data as specified by the mapping file, wherein the correspondence is represented by elements of the mapping file; processing elements of the mapping file to obtain XML elements and/or attributes and generate corresponding RDF resources; and generating the RDF data by using the generated RDF resources. A corresponding transformation engine apparatus is configured to perform the foregoing method.

### CROSS REFERENCE TO RELATED APPLICATION

This application claims priority under 35 U.S.C. 119 from Chinese Patent Application 200910203107.5, filed May 27, 2009, the entire contents of which are incorporated herein by reference.

### BACKGROUND OF THE INVENTION

1. Field of the Invention

The present invention relates to the field of web data processing technology and, more particularly, to a method and system for transforming Extensible Markup Language data to Resource Description Framework data.

2. Description of Related Art

Extensible Markup Language (XML), a standardized markup language, is popularly used as a form of data interaction across platforms in web. It explains data in terms of the content thereof, carries data information, and finally expresses the data by different formatting description means. In practice, however, many domain-specific languages, which like “dialects”, are used among XML documents in web. These expressions are quite arbitrary and thus build a barrier to understanding across domains or fields.

Resource Description Framework (RDF), proposed by The World Wide Web Consortium (W3C), is a set of technical standards for markup languages, in order to describe and express the content and structure of web resources adequately. Specifically, RDF provides standards for describing resources in the form of subject-predicate-object statements. It uniquely identifies resources with Uniform Resource Identifiers (URI) and describes them with simple properties and values of properties, thereby achieving data integration on web.

W3C has proposed a solution for transforming XML data to RDF data, i.e., Gleaning Resource Descriptions from Dialects of Language (GRDDL). The basic idea behind GRDDL is that it utilizes Extensible Stylesheet Language Transformations (XSLT) to write transformation codes, extracts data from relevant XML documents, composes the extracted data, and finally outputs RDF data (RDF/XML).

However, GRDDL has many problems, one of which is bad readability of XSLT used by GRDDL. XSLT is an XPath-based translation language. Using XSLT, people can select data from given XML documents by specifying a desired data path (XPath) and generate desired RDF data in a way like concatenating character strings. However, it should be noted that the generated RDF data usually follows some pre-defined ontology models. Hence, it is hard to represent the logic inside the ontology to readers by using XSLT programming language. As a result, other people can hardly understand existing GRDDL scripts, let alone maintain or revise them. In addition, it is difficult to effectively process complex relationships within XML by using GRDDL. For example, XML allows for recursive data, whereas XSLT scripts do not provide the ability to process such recursive structures efficiently. Therefore, when processing recursive XML data, users must write XSLT scripts based on XML instances but not on XML document schema structures. This is obviously a time-consuming procedure.

Hence, there is a need for a new solution to transform XML data to RDF data.

### SUMMARY OF THE INVENTION

To overcome drawbacks existing in the prior art, the present invention proposes a new solution to transform XML data to RDF data based on a mapping file, wherein the mapping file defines the correspondence between XML elements and/or attributes in the XML data and concepts of the RDF data. It is possible to automatically generate the target RDF data from XML data based on the mapping file as provided.

According to a first aspect of the present invention, a computer-implemented method for transforming Extensible Markup Language (XML) data to Resource Description Framework (RDF) data, includes: receiving a predefined mapping file which includes elements specifying correspondence between at least two of (i) XML elements, (ii) attributes in the XML data and (iii) properties and concepts of the RDF data; retrieving said specified correspondence; processing elements of the mapping file to obtain at least one of (i) XML elements and (ii) attributes; generating corresponding RDF resources; and generating the RDF data by using the generated RDF resources.

According to another aspect of the present invention, apparatus for transforming Extensible Markup Language (XML) data to Resource Description Framework (RDF) data, includes: means for receiving a predefined mapping file; means for retrieving the correspondence between XML elements and attributes in the XML data and properties and concepts of the RDF data as specified by the mapping file, wherein the correspondence is represented by elements of the mapping file; means for processing elements of the mapping file to obtain XML elements and/or attributes and generate corresponding RDF resources; and means for generating the RDF data by using the generated RDF resources.

With the present invention, the relationship between XML elements and/or attributes in the XML data and concepts of the RDF data is described with a mapping file, so that users do not need to directly select data from XML documents by composing codes as GRDDL. Introduction of the mapping file according to the transformation solution of the present invention, which is easier to read and understand than code scripts, makes it convenient to maintain and extend the functionality of systems. Further, the mapping file can be extended by designing elements it comprises, to support new features that are advantageous to transformation in a specific fashion.

### BRIEF DESCRIPTION OF THE DRAWINGS

As the present invention is better understood, other objects and effects of the present invention will become more apparent and easy to understand from the following description, taken in conjunction with the accompanying drawings wherein:

FIG. 1 schematically depicts a method for transforming XML data to RDF data according to an embodiment of the present invention;

FIG. 2 depicts a basic structure of a mapping file according to an embodiment of the present invention;

FIG. 3 depicts an example of a mapping file specified for concrete XML data and target RDF data and based on the structure as shown in FIG. 2;

FIG. 4 depicts an exemplary extension structure of a mapping file according to an embodiment of the present invention;

FIG. 5 depicts an example of a mapping file specified for concrete XML data and target RDF data and based on the extension structure of the mapping file as shown in FIG. 4;

FIG. 6 depicts an example of a mapping file specified for concrete XML data and target RDF data and based on the extension structure of the mapping file as shown in FIG. 4; and

FIG. 7 is a schematic view of a transformation engine according to an embodiment of the present invention.

Like reference numerals designate the same, similar, or corresponding features or functions throughout the drawings.

### DESCRIPTION OF THE PREFERRED EMBODIMENTS

Before a detailed description is given of the specific embodiments of the present invention, the background of RDF data will be described in brief, which helps to understand the present invention.

In the RDF data, each thing (resource) belongs to a class. A resource is identified with a Uniform Resource Locator, and resources are described with simple properties and property values. The described resource has some properties, which, in turn, have respective values. Thus, in the RDF data, resources can also be described with statements of properties and values specifying the resources. RDF uses a set of specific terms to express each part of a statement. That is, in a statement of resources, the part for representing resources is termed subject, the part for differentiating every different property of a target subject of the statement is termed predicate, and the part for differentiating the value of each property is termed object. In the present disclosure, concept-level elements of RDF data that constitute the RDF data, such as classes, properties, property values and so on are termed RDF concepts of RDF data.

Instead of directly selecting data from XML documents with codes as GRDDL, the present invention utilizes a mapping file to describe relationships between XML elements and/or attributes of XML data and RDF concepts of RDF data. A user specifies the correspondence between XML elements and/or attributes and RDF concepts of RDF data with a mapping file and transforms XML elements and/or attributes in the XML data obtained from XML data to target RDF data based on the mapping file.

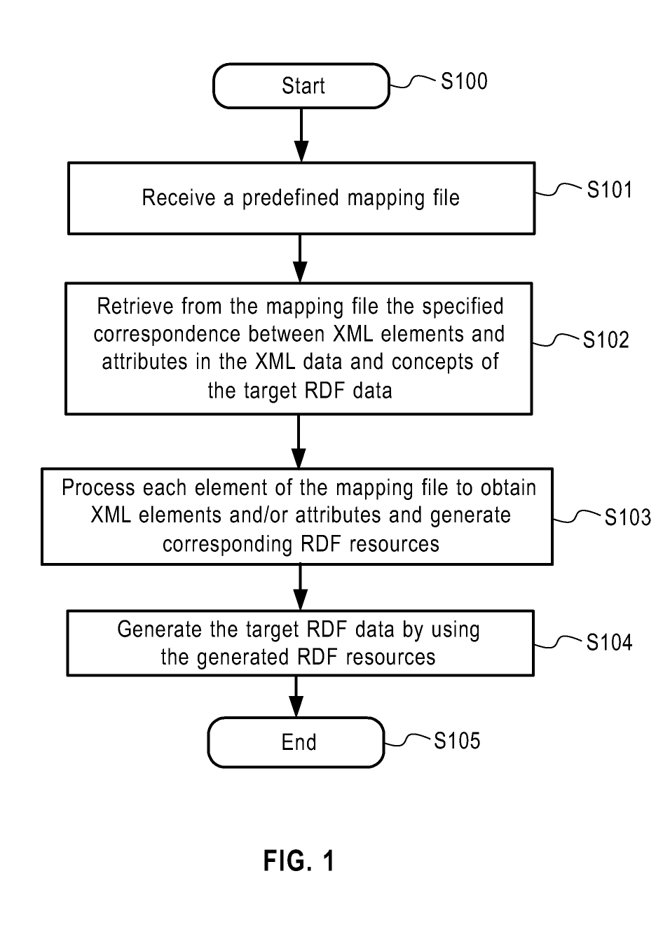

FIG. 1 schematically depicts a method for transforming XML data to RDF data according to an embodiment of the present invention. The flow of the method starts in step S100.

In step S101, a predefined mapping file is received. This mapping file has a given basic structure so that a user can represent the correspondence between concrete XML elements and/or attributes in the XML data and concepts of the target RDF data by specifying the correspondence between the XML elements and/or attributes and respective elements (i.e., nodes, child nodes, bridges, etc.,) in the mapping file.

In step S102, the specified correspondence between XML elements and/or attributes in the XML data and concepts of the target RDF data in the mapping file is retrieved. The correspondence is represented by elements of the mapping file.

In step S103, each element in the mapping file is processed in order to obtain XML elements and/or attributes and generate corresponding RDF resources. As is clear from the following description, the specific procedure of the processing step depends on the structure of the mapping file and/or the configuration of concrete information in the mapping file. It is to be understood from the following specific embodiments that the procedure of this processing step varies dependent upon different structure of the mapping file and/or different configurations of concrete information therein. The acquisition of XML elements and/or attributes from an XML file can be implemented by any means that is known in the art. In the following description of the specific embodiments, corresponding XML elements and/or attributes are specified by means of XPath and acquired from an XML file. Those skilled in the art can, however, appreciate that such illustration is exemplary and not limiting the present invention.

In step S104, target RDF data is generated according to the generated RDF resources.

The flow of the method ends in step S105.

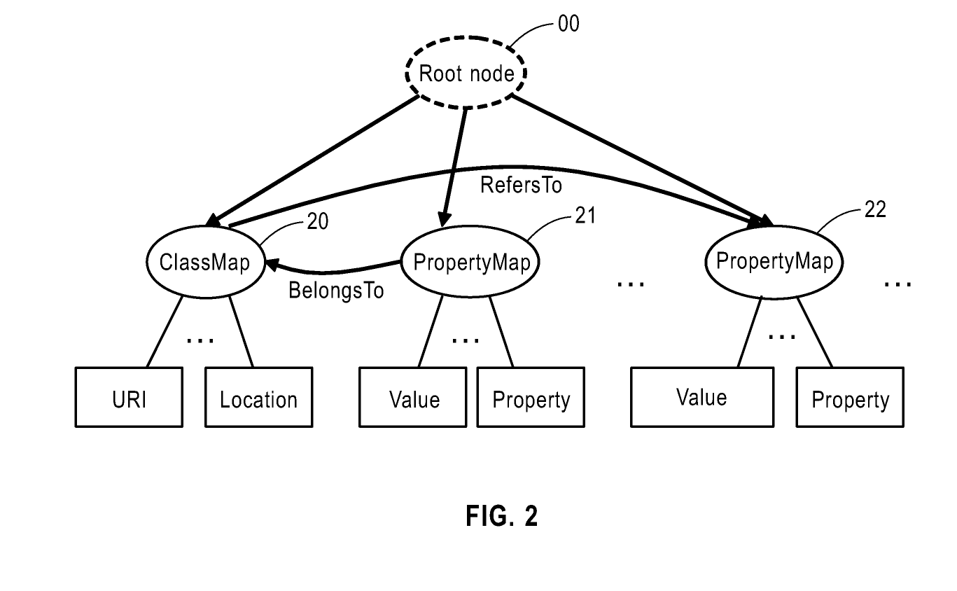

FIG. 2 depicts a basic structure of a mapping file according to an embodiment of the present invention. The mapping file generalizes concepts of the RDF data into corresponding elements. By specifying the correspondences between concrete XML elements and/or attributes and elements in the mapping file, a user can thus represent the correspondences between these XML elements and/or attributes in the XML data and concepts of the target RDF data, perform the steps as depicted in FIG. 1, and generate target RDF data finally. The basic structure of the mapping file as depicted in FIG. 2 generalizes concepts of RDF data into classes and properties.

As depicted in FIG. 2, the basic structure of the mapping file comprises such elements as a root node 00, a ClassMapping node (hereinafter referred to as ClassMap) 20, a plurality of PropertyMapping nodes (hereinafter referred to as PropertyMap) 21 and 22, as well as PropertyBridges associating the ClassMap with the PropertyMaps.

Root node 00 is a virtual node, which can be understood as an initial node processing this map.

ClassMap 20 corresponds to an RDF class (OWL ontology or RDFS schema), for directly specifying the set of RDF data in this class and mapping XML elements and/or attributes to this class. XML elements and/or attributes in the XML data which correspond to this class of RDF data can be located via the ClassMap during transformation. ClassMap 20 defines a class name that identify instances of the class and has a set of PropertyBridges which attach PropertyMaps 21, 22 to the instances. A PropertyMap indicates instances of a property or a set of properties of the RDF data. PropertyMaps 21 and 22 correspond to a property or a set of properties of the RDF data (OWL ontology or RDFS schema), for directly specifying the property or the set of properties or mapping XML elements and/or attributes to the property or the set of properties.

XML elements and/or attributes in the XML data which correspond to a property or a set of similar properties of the RDF data can be located through the PropertyMaps during transformation. The PropertyBridge bridges a ClassMap and a PropertyMap, which attaches an element(s) corresponding to the subject (e.g., an instance(s) of a class) and an elements corresponding to the object(s) (e.g., a value of a property or an instance(s) of a class) in the mapping file to PropertyMaps 21 and 22. Elements of the subject and/or object in RDF data with respect to the PropertyMap are determined according to PropertyBridges during transformation.

Each of ClassMap and PropertyMap nodes comprises a plurality of features describing a specific instance. These features are shown as a plurality of child nodes of each node in the basic structure of the mapping file as depicted in FIG. 2.

ClassMap 20 comprises an identification child node for representing the identification (ID) of the instances of the RDF data. Although this child node is shown as a Uniform Resource Identifier (URI) child node in FIG. 2, the type of the identification of the class may be any one of a Uniform Resource Identifier, a word (excluding character strings of a reserved word), a sequence, a function, and an XPath expression. ClassMap 20 further comprises a location child node for specifying a location where XML elements and/or attributes occur in the XML data. According to an embodiment of the present invention, the location child node is in the type of an XPath expression. When XML elements and/or attributes corresponding to a class of RDF data are being located with the ClassMap in transformation of XML data to RDF data, the identification of the class can be uniquely specified by the identification, and a location where XML elements and/or attributes in the XML data which correspond to an instance(s) of the class is determined by this location.

Each of PropertyMaps 21 and 22 comprises XML elements and/or attributes in the XML data which specify an instance corresponding to defined properties, which are shown as a property child node in FIG. 2. The type of the property child node may be any one of a Uniform Resource Identifier, a sequence, a function, and an XPath expression. Each of PropertyMaps 21 and 22 further comprises a child node indicating the value of a defined property, which is shown as a value child node in FIG. 2. The type of the value child node may be any one of a word (excluding character strings of a reserved word), a sequence, a function, and an XPath expression. When XML elements and/or attributes corresponding to properties of RDF data are being located with the PropertyMaps in transformation of XML data to RDF data, XML elements and/or attributes corresponding to an instance(s) of the property can be determined by the property, and the value of the property can be determined by the value.

PropertyBridge includes two bridging forms: belongsTo and refersTo. A PropertyBridge of belongsTo is shown as an arrow from a PropertyMap to a ClassMap in FIG. 2, meaning that this PropertyMap belongs to this ClassMap. This indicates the ClassMap acting as the subject of RDF data with respect to the PropertyMap. A PropertyBridge of refersTo is shown as an arrow from a ClassMap to a PropertyMap, representing a bridging relationship contrary to that of a PropertyBridge of belongsTo, i.e., this PropertyMap refers to this ClassMap. This indicates the ClassMap acting as the object of RDF data with respect to the PropertyMap. When elements of the subject and/or object of RDF data with respect to the PropertyMap are being determined according to the PropertyBridges in transformation of XML data to RDF data, a ClassMap is an “input” of a PropertyMap if the ClassMap and the PropertyMap are bridged by a PropertyBridge of belongsTo; a ClassMap is an “output” of a PropertyMap if the ClassMap and the PropertyMap are bridged by a PropertyBridge of refersTo.

The inclusion of PropertyBridges in the basic structure of the predefined mapping file as shown in FIG. 2 makes it possible to visually reflect the relationship between a class and a property of the target RDF data and provides convenience for a user to specify corresponding XML elements and/or attributes. For example, when XPath is used as the data type of a property child node, the reserved word $input can be used for delivering XML elements and/or attributes corresponding to an instance(s) of a defined ClassMap to a PropertyMap bridged by a PropertyBridge of belongsTo, and the reserved word $output can be used for delivering XML elements and/or attributes corresponding to an instance(s) of a defined ClassMap to a PropertyMap bridged by a PropertyBridge of refersTo. This helps users to simplify the specifying procedure.

The configuration of the predefined mapping file is quite flexible. For example, the basic structure of the mapping file as shown in FIG. 2 can be extended to have new features so as to be capable of processing complex XML data relationships and target RDF data, which will be described below.

It should be noted although the basic structure of the mapping file is shown as a graph in FIG. 2, those skilled in the art would appreciate that the mapping file is a declarative language to describe the relationship between RDF data and XML data.

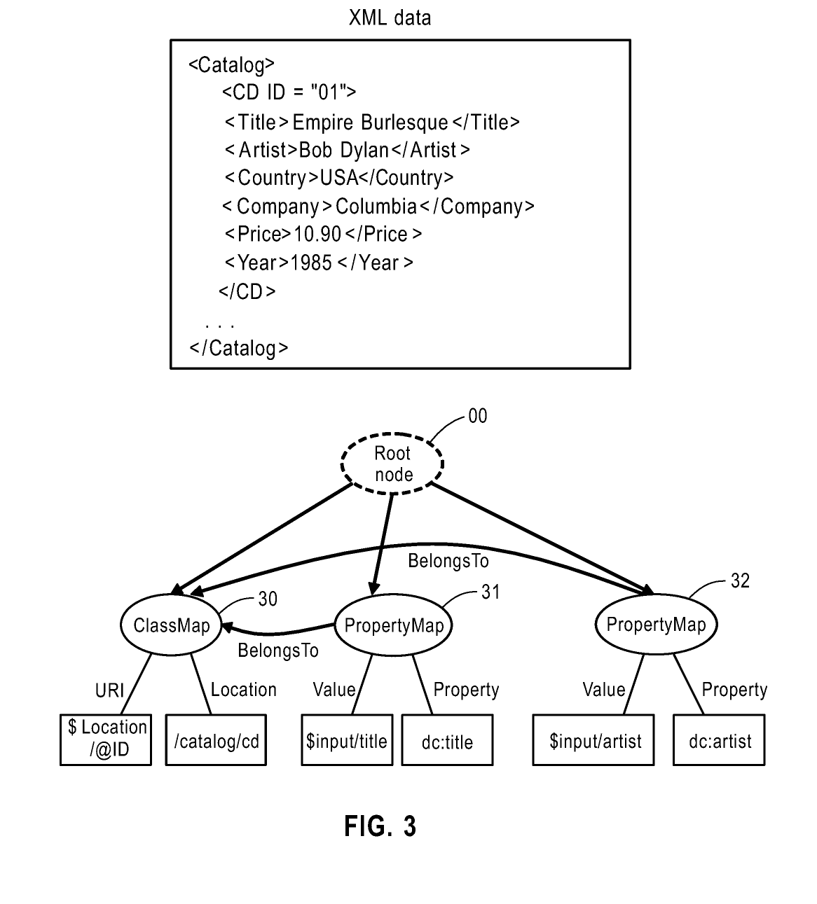

FIG. 3 is an example of a mapping file specified for specific XML data and target RDF, based on the basic structure of the mapping file as shown in FIG. 2.

FIG. 3 presents a piece of exemplary XML data, which describes information on “CD” in “catalog,” including “title,” “artist,” “country,” “company,” “price,” and “year.”

It is desirable that respective information items of each CD are listed as corresponding concepts of RDF data. Thus, a user specifies the correspondence between XML elements and/or attributes and concepts of the target RDF data based on the basic structure of the mapping file as shown in FIG. 1.

As shown in FIG. 3, a ClassMap 30 corresponds to a set of similar classes “CD” of the RDF data. A location child node of ClassMap 30 specifies via XPath that a location where instances corresponding to a defined class appears is “/catalog/CD.” It is seen that the type of the location child node is an XPath expression. In this example, the type of an identification child node is also an XPath expression “$location/@id,” indicating that the identification of this class is a value of “id” under “/catalog/CD”, which is designated by “location.” That is, the identification of CD is “01.” “$location” is a reserved word for indicating XML elements corresponding to this node.

ClassMap 30 has two PropertyBridges which are both belongsTo and which are respectively linked to PropertyMaps 31 and 32 to indicate that PropertyMaps 31 and 32 belong to ClassMap 30.

A property child node of PropertyMap 31 is “dc:title”, which is a corresponding property expression in the target RDF data. This is known to users on the basis of knowledge of the target RDF data. A value child node of PropertyMap 31 is an XPath-type expression “$input/title.” A reserved word “$input” is for delivering XML elements and/or attributes corresponding to an instance(s) of a defined ClassMap to a PropertyMap linked by a PropertyBridge of belongsTo. Here, the reserved word “$input” denotes “/catalog/CD,” and “$input/title” indicates “/catalog/CD/title” in the XML data. It can be appreciated that PropertyMap 31 corresponds to “title” information in XML information of the described CD at this point.

Similarly, a property child node of PropertyMap 32 is “dc:artist”, which is a corresponding property expression in the target RDF data. This is also known to users on the basis of knowledge of the target RDF data. A value child node of PropertyMap 32 is an XPath-type expression “$input/artist.” Here, the reserved word “$input” denotes “/catalog/CD,” and “$input/artist” indicates “/catalog/CD/artist” in the XML data. It can be appreciated that PropertyMap 32 corresponds to “artist” information in XML information of the described CD at this point.

Those skilled in the art would appreciate that more PropertyMaps belonging to ClassMap 30, though not shown in FIG. 3, may be defined in order to map other information (e.g., “country,” “company,” “price,” “year,” etc.,) that describe CDs in the XML data to corresponding RDF property expressions, and thereby generate desired RDF data.

Based on the predefined mapping file as shown in FIG. 3, an XPath expression indicating corresponding XML elements and/or attributes can be obtained by processing the ClassMap and the PropertyMaps in term of the PropertyBridges. For example, corresponding XML elements and/or attributes can be obtained from the XML file as shown in FIG. 3 by XPath processing means included in a transformation engine, and corresponding RDF resources can be generated. Thus, the transformation engine can transform XML data to target RDF data. In the example as shown in FIG. 3, RDF statements obtained from the transformation read below:

01 dc:title Empire Burlesque
01 dc:artist Bob Dylan
...
...

In the case of an XSLT language-based transformation method in GRDDL is to be used in the prior art, the following XSLT scripts need to be written for transforming XML data as shown in FIG. 3 to the above-described RDF data.

<xsl:template match=″/″>

<xsl:for-each select=“catalog/CD″>

<xsl:value-of select=“@id“>

dc:title

<xsl:value-of select=“title″/>
<xsl:value-of select=“@id“>

dc:artist

<xsl:value-of select=“artist″/>

</xsl:for-each>

</xsl:template>

Unlike the mapping file as shown in FIG. 3, such XSLT scripts cannot visually reflect the correspondence between XML elements and/or attributes and RDF concepts. To write XSLT scripts, the user must master knowledge of XML data transformation and RDF data and be familiar with commands of XSLT. In addition, compared with the mapping file as shown in FIG. 3, XSLT scripts are more difficult to read and understand so that it is very hard to conduct subsequent functional maintenance and extension.

The mapping file as shown in FIG. 3 directly embodies the correspondence between concepts of the target RDF data and corresponding XML elements and/or attributes in the XML data. Considering that users who transform XML data to RDF data are quite familiar with target RDF data in practice, such users can usually achieve specifying a mapping file of the present invention more conveniently. In particular, it is possible to make the mapping file easier to read and understood in the form of a graph and thus suitable for maintenance and further development.

As described above, the mapping file can be extended to include more features based on the basic structure of the mapping file as shown in FIG. 2, in order to support complex relationships in the XML data or specific expressions in the target RDF data.

The extensibility of the mapping file according to the present invention will be described by way of concrete examples. However, those skilled in the art would appreciate that the example to be given is illustrative and not exhaustive. They may extend the structure of the mapping file to support desired features according to circumstances where XML data is transformed to RDF data and under the basic idea of the present invention. In particular, the extensibility is more flexible considering that the mapping file in the present invention is based on a declarative language. It is to be understood that technical solutions of transforming XML data to RDF data by using various mapping files which have been obtained from extension are variations of the specific embodiments of the present invention and still fall within the scope of the present invention.

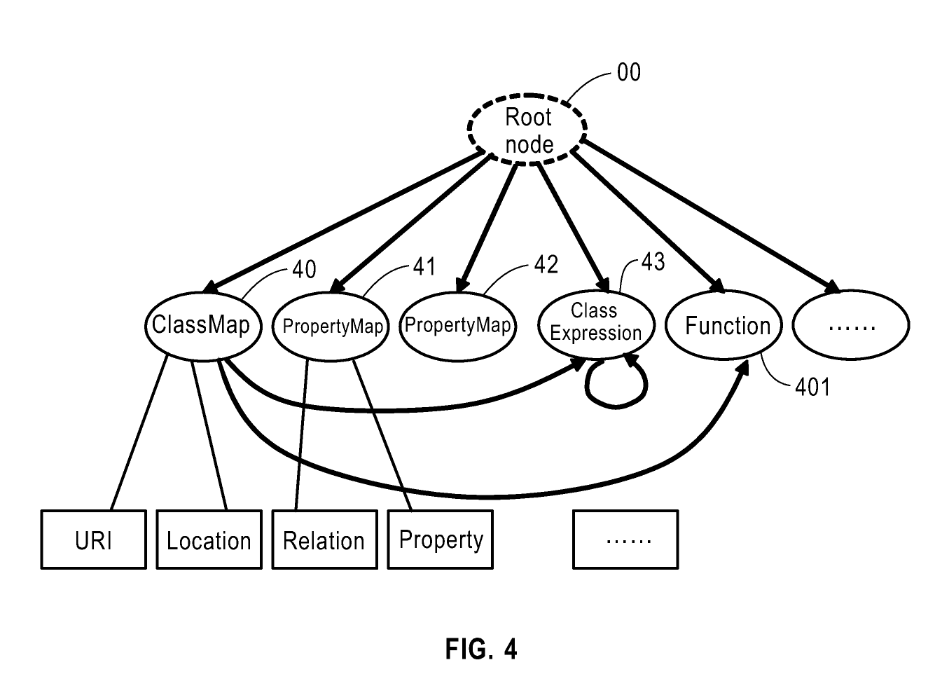

FIG. 4 depicts an exemplary extension structure of the predefined mapping file as shown in FIG. 1.

As shown in FIG. 4, the extended mapping file comprises root node 00, a ClassMap 40, and PropertyMaps 41 and 42.

Different from the basic structure shown in FIG. 2, the extension structure comprises a function node 401 for defining a mechanism with which the user generates specific data, so as to generate specified content of any element in the mapping file in transformation of XML data to RDF data. In this example, the data generating mechanism defined by function node 401 can be used for generating the content of an identification child node of ClassMap 40, to denote the identification of the class of the RDF data. It can be understood that when the class identification of ClassMap 40 is generated through function node 401, the type of the class identification is a function. However, it should be noted that those skilled in the art may utilize any known technical means to implement the data generating mechanism represented in function node 401, such as a specific sequence generating mechanism, a URI extracting mechanism, and so on. The concrete generating mechanism will not be described in details here.

The value child node which each of PropertyMaps 41 and 42 comprises can be extended. When the value child node is in the type of an XPath expression, it is extended to further support an XPath-like expression, so as to denote the relative path between instances of the classes. To differ from an unextended value child node in terminology, the extended value child node is called relational child node, which is for indicating the relation from a ClassMap attached through the PropertyBridge of belongsTo to a ClassMap attached through the PropertyBridge of refersTo. The XPath-like expression differs from the XPath expression in two aspects: 1) it must start with “/” to indicate it is a relative context XPath expression from the PropertyBridge of belongsTo; 2) it must end with “//” or “/” to demonstrate the relationship to the PropertyBridge of refersTo.

The extension structure further comprises a class expression node (hereinafter referred to as a class expression) 43 for constructing a target RDF class, i.e., for constructing ClassMap 40 (shown as an arrow pointing from ClassMap 40 to class expression 43 in FIG. 4). Class expression 43 can also be attached to another expression and thus is defined by the another expression iteratively (shown as an arrow pointing to itself in FIG. 4). During transformation of XML data to RDF data, the class expression is used for constructing at a proper location of a character string a class expression of the target RDF data that contains corresponding XML elements and/or attributes of XML data.

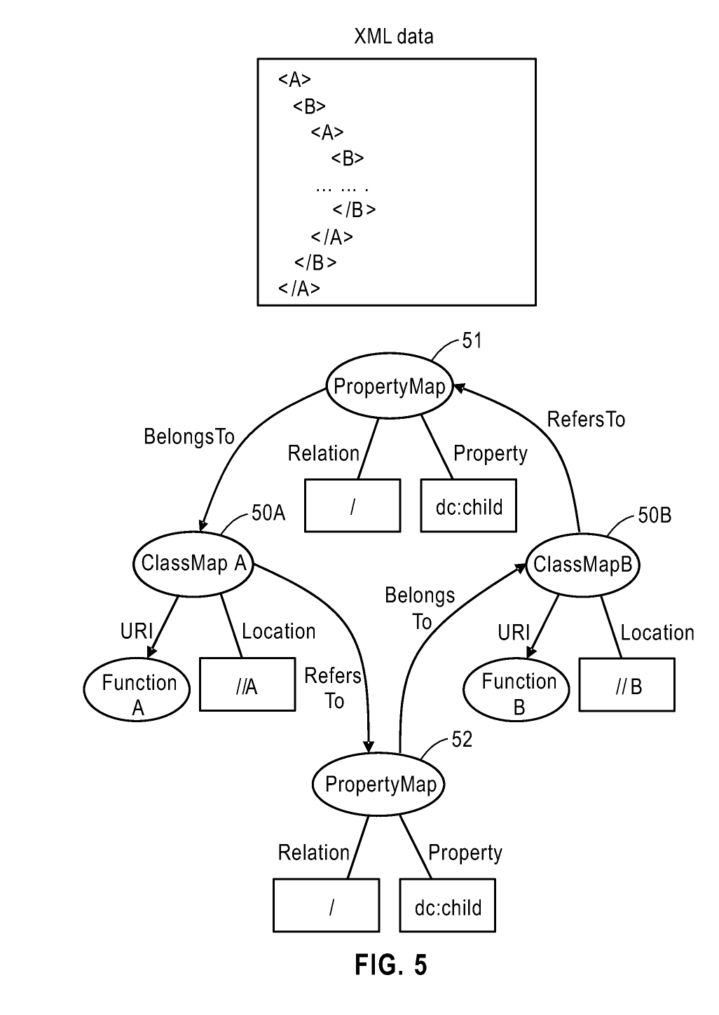

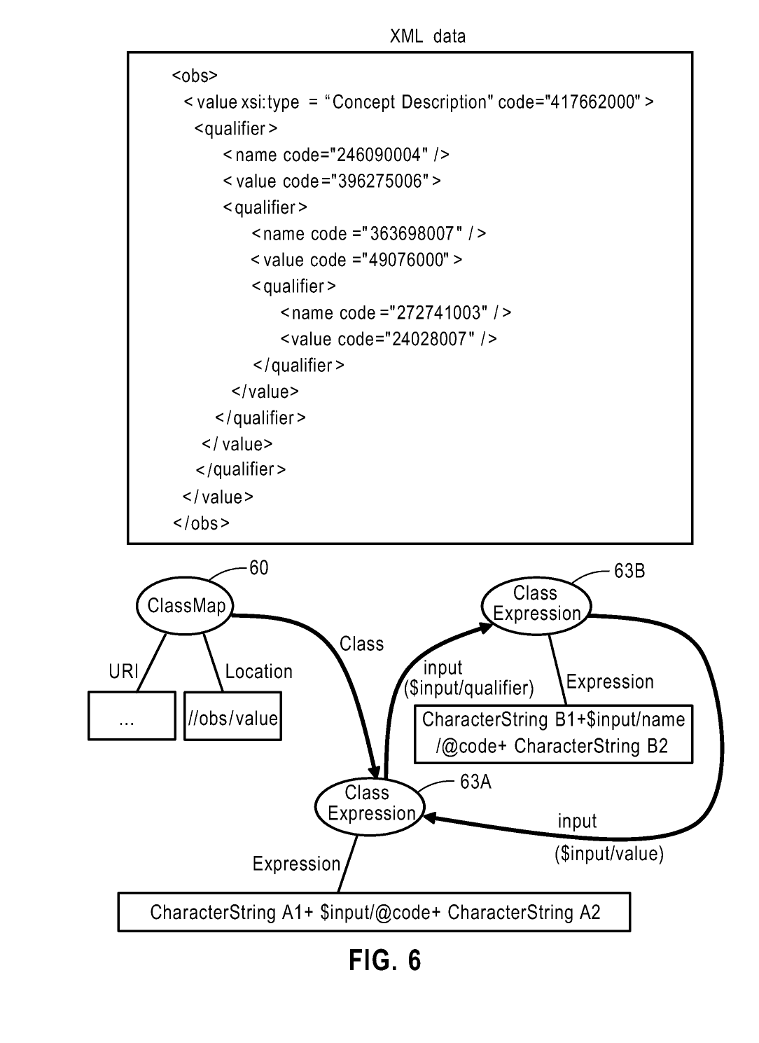

Description is given below to transformation of XML data to RDF data by using the extension structure of the mapping file as shown in FIG. 4 in the context of examples as shown in FIGS. 5 and 6.

FIG. 5 is a concrete example of a mapping file specified for XML data and target RDF data, on the basis of the extension structure of the mapping file as shown in FIG. 4. In this example, a function node, a newly extended feature of the mapping file is applied to support requirements on class identification in the target RDF data, and relation child nodes of the PropertyMaps are applied to support processing of recursive relationships in the XML data.

As shown in FIG. 5, the XML data is of a recursive structure consisting of tags A and B (elements between a start tag and an end tag are omitted for purposes of simplification). As shown in this figure, the target RDF data needs to express the recursive structure of the XML data in the form of RDF statements and to serially number the tags forming the recursive structure.

ClassMaps 50A and 50B are defined for “A” and “B”, respectively. A location child node of ClassMap 50A specifies with XPath that a location where instances corresponding to the defined class appear is “//A.” That is, “A” is directly searched for irrespective of paths. The type of an identification child node of ClassMap 50A employs a function node (function A) to provide a mechanism for serial numbering. Accordingly, a location child node of ClassMap 50B specifies that a location where instances corresponding to a defined class appear is “//B.” That is, “B” is directly searched for irrespective of paths. The type of an identification child node of ClassMap 50B employs a function node (function B) to provide a mechanism for serial numbering.

The respective recursive structure of “A” and “B” in the XML data can be expressed by arranging PropertyMaps 51 and 52 each of which has a relation child node.

PropertyMap 51 is attached to ClassMap 50A through the ProrpertyBridge of belongsTo and to ClassMap 50B through the PropertyBridge of refersTo. A relation child node of PropertyMap 51 has a value of “/”, which indicates the relative path from a corresponding instance of ClassMap 50A to a corresponding instance of ClassMap 50B. A property child node of PropertyMap 51 denotes “dc:child”, which is the expression of the corresponding property in the target RDF data. PropertyMap 52 is attached to ClassMap 50B through the PropertyBridge of belongsTo and to ClassMap 50A through the PropertyBridge of refersTo. A relation child node of PropertyMap 52 has a value of “/”, which indicates the relative path from a corresponding instance of ClassMap 50B to a corresponding instance of ClassMap 50A. A property child node of PropertyMap 52 denotes “dc:child”, which is the expression of the corresponding property in the target RDF data.

The recursive structure in the XML data is easily exhibited by arranging the PropertyMaps attached to the ClassMaps in the mapping file, as shown in FIG. 5. That is, PropertyMap 51 indicates the case that “A” includes “B”, and PropertyMap 52 indicates the case that “B” includes “A”.

XPath expressions indicating corresponding XML elements and/or attributes can be obtained by processing the ClassMaps and the PropertyMaps having relation child nodes in term of the PropertyBridges, based on the predefined mapping file as shown in FIG. 5. The transformation engine may further comprise function processing means to support processing of the structure of the mapping file supporting extended features. For example, the function processing means may provide various number generating mechanisms. For another example, corresponding XML elements and/or attributes can be obtained from the XML data as shown in FIG. 5 by XPath processing means included in the transformation engine, and corresponding RDF resources can thus be generated. Thus, the transformation engine can transform XML data to the target RDF data based on the mapping file. In the example as shown in FIG. 5, RDF statements from the transformation read below:

a1 dc:child b1
b1 dc:child a2
a2 dc:child b2
. . .

In the case of an XSLT language-based transformation method in GRDDL is to be used in the prior art, the following XSLT scripts need to be written for transforming XML data as shown in FIG. 5 to the above-described RDF data.

<xsl:template match=″/″>

<xsl:for-each select=“A″>

<xsl:variable name=“firstA“, select=“′a1′”>
<xsl:for-each select=“B″>

<xsl:variable name=“firstB“, select=“′b1′”>
<xsl:copy-of select=“firstA” /> dc: child

<xsl:copy-of select=“$firstB” />

<xsl:for-each select=“A″>

......
......
......
......

</xsl:for-each>
</xsl:for-each>

</xsl:for-each>

</xsl:template>

As is clear from the above script, where there is recursive structure in the XML data, XSLT loops as many as the levels of the recursive structure need to be composed, in order to generate the target RDF data. This is obviously both time and effort consuming. In some cases, e.g., based on an XML schema only, it is hard to learn how many levels in the recursive structure are existed. At this point, transformation cannot be fulfilled by coding XSLT script. Therefore, the mapping file shown in FIG. 5 has incomparable advantages over GRDDL in terms of depicting the complex structure of XML data.

FIG. 6 depicts an example of a mapping file specified for concrete XML data and target RDF data and based on the extension structure of the mapping file as shown in FIG. 4. Class expression nodes are utilized to support the generation of target RDF class expressions containing XML elements and/or attributes in the XML data.

A ClassMap 60 corresponds to a class of the target RDF. A location child node specifies that a location where instances corresponding to a defined class is “//obs/value.” The identification child node may denote the identification of this class.

ClassMap 60 has a link to a class expression 63A, which directly delivers the definition of this class to class expression 63A. An expression child node of class expression 63A defines an RDF class expression to be generated, which contains, at a proper location, desired XML elements and/or attributes of the XML data. This expression is schematically expressed as “CharacterString A1+$input/@code+CharacterString A2.” Class expression 63A may further be attached to another class expression 63B which acts as its child node. The input to class expression 63B is “$input/qualifier,” wherein “$input” represents the input to class expression 63A, i.e., “//obs/value”.

An expression child node of class expression 63B defines an RDF class expression to be generated, which contains, at a proper location, desired XML elements and/or attributes of the XML data. This expression is schematically expressed as “CharacterString B1+$input/name@code+CharacterString B2.” Class expression 63B may be attached to another class expression which acts as its child node. In particular, class expression 63B may be attached back to class expression 63A and specify that the input to class expression 63A is “$input/value,” wherein “$input” represents the input to class expression 63B, i.e., “//obs/value/qualifier”. At this point, the expression child node “characterstring A1+$input/@code+characterstring A2” of class expression 63A represents “characterstring A1+//obs/value/qualifier/value/@code+characterstring A2.”

It can be understood that the recursive structure consisting of “qualifier” and “value” in the XML data is described by nesting of class expressions.

An XPath expression indicating corresponding XML elements and/or attributes can be obtained by processing the class expressions which constructs the target RDF data that contains XML elements and/or attributes of XML data at a proper location of a character string, based on the predefined mapping file as shown in FIG. 6. The transformation engine may comprise expression processing means to support processing of the structure of the mapping file supporting extended features. The transformation engine retrieves respective XML elements “code” from XML data shown in FIG. 6 via the XPath processing means it comprises, which XML elements form target RDF data together with character strings according to the output of the expression processing means. According to the mapping file shown in FIG. 6, a possible RDF statement obtained from transformation is illustrated below.

<owl:Class>

<owl:intersectionOf rdf:parseType=“Collection”>

<owl:Class rdf:about=“http://umrr.dyn.webahead.ibm.com/2008/metamodel/sct/code_417662000”/>
<owl:Restriction>

<owl:onProperty rdf:resource=“http://umrr.dyn.webahead.ibm.com/2008/metamodel/sct/code_246090004”/>
<owl:someValuesFrom>

<owl:Class>

<owl:intersectionOf rdf:parseType=“Collection“>

<owl:Class rdf:about=“http://umrr.dyn.webahead.ibm.com/2008/metamodel/sct/code_396275006”/>
<owl:Restriction>

<owl:onProperty rdf:resource=“http://umrr.dyn.webahead.ibm.com/2008/metamodel/sct/code_363698007”/>
<owl:someValuesFrom>

<owl:Class>

<owl:intersectionOf rdf:parseType=“Collection”>

<owl:Class rdf:about=“http://umrr.dyn.webahead.ibm.com/2008/metamodel/sct/code_49076000“/>
<owl:Restriction>

<owl:onProperty
rdf:resource=“http://umrr.dyn.webahead.ibm.com/2008/metamodel/sct/code_272741003”/>
<owl:someValuesFrom
rdf:resource=“http://umrr.dyn.webahead.ibm.com/2008/metamodel/sct/code_24028007”/>

</owl:Restriction>

</owl:intersectionOf>

</owl:Class>

</owl:someValuesFrom>

</owl:Restriction>

</owl:intersectionOf>

</owl:Class>

</owl:someValuesFrom>

</owl:Restriction>

</owl:intersectionOf>

</owl:Class>

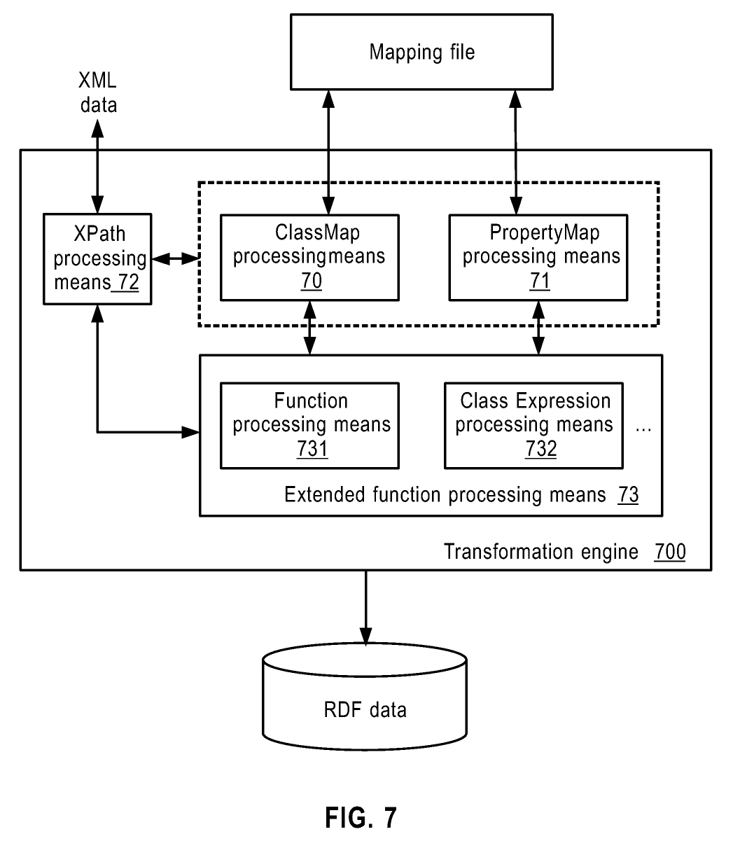

FIG. 7 is a schematic view of a transformation engine according to an embodiment of the present invention.

As shown in FIG. 7, XML data to be transformed serves as an input to a transformation engine 700 according to the present invention. Transformation engine 700 receives a predefined mapping file. The mapping file has a structure as illustrated in at least one of FIGS. 2-6, so that a user can represent the correspondence between XML elements and/or attributes in the XML data and concepts of the target RDF data by specifying the correspondence between concrete XML elements and/or attributes and respective elements (e.g., a node, child node, bridge, etc.,) in the mapping file.

Transformation engine 700 is configured to retrieve the correspondence as specified in the mapping file between XML elements and/or attributes and concepts of the target RDF data.

Transformation engine 700 processes each element in the mapping file so as to obtain XML elements and/or attributes and generate corresponding RDF resources. For example, dependent on the basic structure of the mapping file described above, transformation engine 700 may comprise corresponding ClassMap processing means 70 for locating XML elements and/or attributes in the XML data which correspond to a set of similar classes of the RDF data, and PropertyMap processing means 71 for locating XML elements and/or attributes in the XML data which correspond to a property or a set of similar properties of the RDF data, wherein elements corresponding to the subject(s) and/or object(s) in RDF data with respect to the PropertyMaps are determined according to PropertyBridges. In the case where the mapping file further comprises extended features to support complex structures of XML data and RDF data, transformation engine 700 preferably comprises extension processing means 73, which, for example, may includes function processing means 731 for generating the specified content of any element in the mapping file, class expression processing means 732 for constructing a class expression of the target RDF data, which contains, at a proper location of a character string, XML elements and/or attributes of XML data, and so on. Based on corresponding extended features in the mapping file, these extension processing means can be used to process XML data with a specific structure (e.g., XML data with a recursive structure) or generate RDF data with specific features.

Transformation engine 700 is configured to obtain XML elements and/or attributes and generate corresponding RDF resources. The transformation engine comprises, for example, XPath processing means 72 for processing XPath expressions to obtain XML elements and/or attributes from XML data. In particular, when corresponding properties of a ClassMap and PropertyMap in the mapping file are in the type of an XPath expression, XML elements and/or attributes are obtained from XML data directly by XPath processing means 72.

During concrete implementations, intermediate RDF element resources (e.g., any element in RDF triplets) might be generated when transformation engine 700 transforms XML data. These intermediate RDF element resources may be temporarily stored in RDF resource storage (not shown) of transformation engine 700. The RDF resource storage may be implemented as part of a memory of a computer system.

Then, transformation engine 700 generates RDF data by using RDF resources.

It should be noted that the concrete construction and processing flow of transformation engine 700 are adapted to the structure of the defined mapping file and the information configuration of this mapping file. Since the predefined mapping file of the present invention is subjected to many variations (e.g., functional extension) on the basis of the basic structure as shown in FIG. 2 and can even adopt any structure capable of specifying the correspondence between XML elements and/or attributes in the XML data and concepts of the target RDF data, many variations of the concrete construction and processing flow of transformation engine 700 are also applicable. It is necessary to enable transformation engine 700 to perform corresponding processing flows for all features as supported by the mapping file.

The concrete processing flow of transformation engine 700 is illustrated by way of example by making reference to the mapping file shown in FIG. 5.

ClassMap processing means 70 implements processing according to, for example, ClassMaps in the mapping file as shown in FIG. 4. For each ClassMap, instances of this class are found in the XML data by XPath processing means 72 according to its location child node; the identification is assigned to each instance, wherein function processing means 731 is invoked to generate a desired URI schema because the identification child node of the ClassMap node is represented by a function node. For example, for ClassMap A 50A, XPath processing means 72 finds each “<A>” appearing in the XML data according to the location “//A.” The URI schema generated by function processing means 731 is a serial number desired by RDF data, i.e., the sequence number where current instance “<A>” appears among XML data.

In a preferred implementation, RDF resources being generated may be temporarily stored in RDF resource storage (not shown) of transformation engine 700.

A PropertyMap processing means 71 implements processing according to, for example, the PropertyMap node in the mapping file as shown in FIG. 5. For each PropertyMap, an instance indicated by the PropertyBridge of belongsTo is retrieved from the XML data by XPath processing means 72; for each instance, its corresponding result is found in the XML data by XPath processing means 72 according to the relation node. An instance indicated by the refersTo bridge is retrieved from XML data by XPath processing means 72. Then, the above result is compared with the instance indicated by the PropertyBridge of refersTo. If the result matches this instance, it is then output or temporarily stored. Otherwise, PropertyMap processing means 71 continues to implement the above-discussed processing. For example, an instance indicated by the propertyBridge of belongsTo, i.e., “<A>” at a certain location, is acquired from the XML data by XPath processing means 72 with respect to PropertyMap 51. For this instance, a corresponding result, i.e., “<B>” under “<A>,” is found in the XML data by XPath processing means 72 according to the relationship represented by relation node “I.” An instance indicated by the PropertyBridge of refersTo, i.e., “<B>,” is acquired from the XML data by XPath processing means 72. If the above result and the instance match, it means that “<A>” and “<B>” satisfy this relationship, and this result is temporarily stored or output as a value in RDF triplets. In a preferred embodiment, RDF resources being generated may be temporarily stored in RDF resource storage (not shown) of transformation engine 700.

After all of input XML data are processed, an RDF statement being generated is output. Typically, the RDF statement is an RDF triplet, i.e., subject, predicate, and object, which respectively correspond to a ClassMap instance, a property child node of a PropertyMap, and a value child node of a PropertyMap in generated RDF resources. In the light of the target RDF data, the subject may further comprise an URI identification of the ClassMap instance, the object may further find a result according to the relation child node, and so on. In this example, RDF data output by transformation engine 700 read below:

a1 dc:child b1
b1 dc:child a2
a2 dc:child b2
............

In another example, transformation engine 700 may support the mapping file as shown in FIG. 6. Thus, it may further comprise class expression processing means 723 in extended function processing means 73. A concrete processing algorithm of class expression processing means 723 may be designed according to the concrete configuration of an extension structure supported in the mapping file. It is easy for those skilled in the art to design a corresponding processing algorithm. Examples are thus omitted here.

Different structures of a mapping file and different configurations of information in the mapping file will lead to different constructions and/or processing flows of transformation engine 700. In addition, those skilled in the art may adopt different algorithms to implement a processing flow of transformation engine 700 even for the same structure of the mapping file and/or the same configuration of information in the mapping file. How to design a concrete processing flow of transformation engine 700, however, is not under discussion of the present invention.

The above description of the present invention has been presented for purposes of illustration, and is not intended to be exhaustive or to limit the invention to the form disclosed. Modifications and alterations will be apparent to those of ordinary skill in the art. It is understood by those skilled in the art that the method and means in the embodiments of the present invention can be implemented in software, hardware, firmware, or a combination thereof.

The embodiments were chosen and described in order to better explain the principles of the present invention, the practical application, and to enable those of ordinary skill in the art to understand that all modifications and alterations made without departing from the spirit of the present invention fall into the protection scope of the present invention as defined in the appended claims.

What is claimed is:

1. A computer-implemented method for transforming Extensible Markup Language (XML) data to Resource Description Framework (RDF) data, comprising the steps of:
receiving a predefined mapping file which includes elements specifying correspondence between at least two of (i) XML elements, (ii) attributes in the XML data and (iii) properties and concepts of the RDF data;
retrieving said specified correspondence;
processing elements of the mapping file to obtain at least one of (i) XML elements and (ii) attributes;
generating corresponding RDF resources; and
generating the RDF data by using the generated RDF resources;
wherein said steps are carried out by a computer device.

2. The method according to claim 1, wherein the step of processing elements of the mapping file comprises:
locating, by a ClassMap, at least one of XML elements and attributes in the XML data which correspond to a set of similar classes of the RDF data, wherein the ClassMap is for directly specifying either (i) a set of similar classes of the RDF data or (ii) mapping at least one of XML elements and attributes in the XML data to a set of similar classes of the RDF data.

3. The method according to claim 2, wherein the step of processing elements of the mapping file further comprises:
locating, by a PropertyMap, at least one of XML elements and attributes in the XML data which correspond to a property or a set of similar properties of the RDF data, wherein the PropertyMap is for directly specifying either a property of a set of similar properties of the RDF data or mapping at least one of XML elements and attributes in the XML data to a property or a set of similar properties of the RDF data; and
determining an element corresponding to at least one of a subject and an object of the RDF data with respect to the PropertyMap according to a PropertyBridge, wherein the PropertyBridge bridges a ClassMap and a PropertyMap.

4. The method according to claim 2, wherein the ClassMap comprises the following child elements:
ID, for representing the identification of the class in the RDF data; and
Location, for specifying a location in the XML data where at least one of XML elements and attributes corresponding to an instance of the class appear,
wherein the step of locating, by a ClassMap, further comprises:
uniquely specifying, by the ID, the identification of the class; and
determining, by the Location, a location in the XML data where XML elements and/or attributes corresponding to an instance of the class appear.

5. The method according to claim 3, wherein the PropertyMap comprises the following child elements:
Property, for specifying at least one of XML elements and attributes in the XML data which correspond to an instance of the property; and
Value, for indicating a value of the property,
wherein the step of locating, by a PropertyMap, further comprises:
determining, by the Property, at least one of XML elements and attributes in the XML data which correspond to an instance of the property; and
determining, by the Value, a value of the property.

6. The method according to claim 3, wherein the PropertyBridge comprises:
at least one of (i) PropertyBridge of belongsTo, which indicates the ClassMap acting as the subject of the RDF data with respect to the PropertyMap; and (ii) PropertyBridge of refersTo, which indicates the ClassMap acting as the object of the RDF data with respect to the PropertyMap,
wherein the step of determining an element corresponding to at least one of a subject and an object of the RDF data with respect to the PropertyMap according to a PropertyBridge further comprises:
at least one of (i) using the ClassMap as the input to the PropertyMap in response to bridging the ClassMap and the PropertyMap by the PropertyBridge of belongsTo; and (ii) using the ClassMap as the output of the PropertyMap in response to bridging the ClassMap and the PropertyMap by the PropertyBridge of refersTo.

7. The method according to claim 4, wherein elements of the mapping file further comprise:
Class Expression, which is attached to a ClassMap or another class expression,
wherein the step of processing elements of the mapping map further comprises:
constructing, by the Class Expression, a class expression of the RDF data which contains XML elements and/or attributes of the XML data at a proper location of a character string.

8. The method according to claim 6, wherein the PropertyMap comprises the following child elements:
Property, for specifying at least one of XML elements and attributes in the XML data which correspond to an instance of the property; and
value, for indicating the relation from a ClassMap attached through a PropertyBridge to a ClassMap attached through a PropertyBridge of refersTo,
wherein the step of locating, by the PropertyMap, further comprises:
determining, by the Property, at least one of XML elements and attributes in the XML data which correspond to an instance of the property; and
linking, by the relationship indicated by the Value, the ClassMap used as the input to the PropertyMap and the ClassMap used as the output of the PropertyMap.

9. The method according to claim 3, wherein elements of the mapping file further comprise:
Function, for defining a mechanism for generating specific data by users,
wherein the step of processing elements of the mapping file further comprises:
generating, by the Function, specified content of any element in the mapping file.

10. The method according to claim 1, wherein at least part of elements of the mapping file are assigned with XPath expression values, and wherein the step of processing elements of the mapping file further comprises:
processing an XPath expression to obtain at least one of XML elements and attributes; and
generating corresponding RDF resources.

11. An apparatus for transforming Extensible Markup Language (XML) data to Resource Description Framework (RDF) data, comprising:
means for receiving a predefined mapping file;
means for retrieving the correspondence between XML elements and attributes in the XML data and properties and concepts of the RDF data as specified by the mapping file, wherein the correspondence is represented by elements of the mapping file;
means for processing elements of the mapping file to obtain XML elements and/or attributes and generate corresponding RDF resources; and
means for generating the RDF data by using the generated RDF resources.

12. The apparatus according to claim 11, wherein the means for processing elements of the mapping file further comprises:
means for locating, by a ClassMap, XML elements and attributes in the XML data which correspond to a set of similar classes of the RDF data, wherein the ClassMap is for directly specifying a set of similar classes of the RDF data or mapping XML elements and attributes in the XML data to a set of similar classes of the RDF data.

13. The apparatus according to claim 12, wherein the means for processing elements of the mapping file further comprises:
means for locating, by a PropertyMap, XML elements and attributes in the XML data which correspond to a property or a set of similar properties of the RDF data, wherein the PropertyMap is for directly specifying either (i) a property of a set of similar properties of the RDF data or (ii) mapping XML elements and attributes in the XML data to a property or a set of similar properties of the RDF data; and
means for determining an element corresponding to a subject and object of the RDF data with respect to the PropertyMap according to a PropertyBridge, wherein the PropertyBridge bridges a ClassMap and a PropertyMap.

14. The apparatus according to claim 12, wherein the ClassMap comprises the following child elements:
ID, for representing the identification of the class of the RDF data; and
Location, for specifying a location in the XML data where XML elements and/or attributes corresponding to an instance of the class appear,
wherein the means for locating, by a ClassMap, XML elements and attributes in the XML data which correspond to a set of similar classes of the RDF data further comprises:
means for uniquely specifying, by the ID, the identification of the class; and
means for determining, by the Location, a location in the XML data where XML elements and attributes corresponding to an instance of the class appear.

15. The apparatus according to claim 13, wherein the PropertyMap comprises the following child elements:
Property, for specifying XML elements and/or attributes in the XML data which correspond to an instance of the property; and
Value, for indicating a value of the property,
wherein the means for locating, by a PropertyMap, XML elements and attributes in the XML data which correspond to a property or a set of similar properties of the RDF data further comprises:
means for determining, by the Property, XML elements and/or attributes in the XML data which correspond to an instance of the property; and
means for determining, by the Value, a value of the property.

16. The apparatus according to claim 13, wherein the PropertyBridge comprises:
PropertyBridge of belongsTo, which indicates the ClassMap acting as the subject of the RDF data with respect to the PropertyMap; and/or
PropertyBridge of refersTo, which indicates the ClassMap acting as the object of the RDF data with respect to the PropertyMap,
wherein the means for determining an element corresponding to the subject and object of the RDF data with respect to the PropertyMap according to a PropertyBridge further comprises:
means for using the ClassMap as the input to the PropertyMap in response to bridging the ClassMap and the PropertyMap by the PropertyBridge of belongsTo; and/or
means for using the ClassMap as the output of the PropertyMap in response to bridging the ClassMap and the PropertyMap by the PropertyBridge of refersTo.

17. The apparatus according to claim 14, wherein elements of the mapping file further comprise:
Class Expression, which is attached to one of a ClassMap and another Class Expression,
wherein the means for processing elements of the mapping map further comprises:
means for constructing, by the Class Expression, a class expression of the RDF data which contains XML elements and attributes of the XML data at a proper location of a character string.

18. The apparatus according to claim 16, wherein the PropertyMap comprises the following child elements:
Property, for specifying XML elements and attributes in the XML data which correspond to an instance of the property;
Value, for indicating the relation from a ClassMap attached through a PropertyBridge to a ClassMap attached through a PropertyBridge of refersTo,
wherein the means for locating, by a PropertyMap, XML elements and attributes in the XML data which correspond to a property or a set of similar properties of the RDF data further comprises:
means for determining, by the Property, XML elements and attributes in the XML data which correspond to an instance of the property;
means for linking, by the relationship indicated by the Value, the ClassMap used as the input to the PropertyMap and the ClassMap used as the output of the PropertyMap.

19. The apparatus according to claim 13, wherein elements of the mapping file further comprise:
Function, for defining a mechanism for generating specific data by users,
wherein the means for processing elements of the mapping file further comprises:
means for generating, by the Function, specified content of any element in the mapping file.

20. The apparatus according to claim 10, wherein at least part of the elements of the mapping file are assigned with XPath expression values,
and wherein the means for processing elements of the mapping file further comprises means for processing an XPath expression to obtain XML elements and attributes and generate corresponding RDF resources.
